(19) United States
(12) Patent Application Publication
(10) Pub. No.: US 2012/0095129 A1
(43) Pub. Date: Apr. 19, 2012

(54) RESIN COMPOSITION

(75) Inventors: Masashi MAMINO, Tokyo (JP); Yasuo KURACHI, Tokyo (JP); Ryuji KITANI, Tokyo (JP); Yasuharu SAITA, Tokyo (JP)

(73) Assignee: KONICA MINOLTA BUSINESS TECHNOLOGIES, INC., Tokyo (JP)

(21) Appl. No.: 13/268,293

(22) Filed: Oct. 7, 2011

(30) Foreign Application Priority Data
Oct. 14, 2010 (JP) JP2010-231190

(51) Int. Cl. C08L 69/00; C08K 5/5333; C08L 23/06; C08K 5/524; C08K 5/521; C08J 3/20; C08L 67/02; C08K 5/5393

(52) U.S. Cl. 523/324; 524/508; 524/513; 524/130; 524/133; 524/139; 524/140

(57) ABSTRACT

Disclosed is a resin composition comprising (A) a polyester resin or a polycarbonate resin, (B) a polyethylene resin, (C) an aromatic compound other than the polyester resin and the polycarbonate resin, the aromatic compound having a residual carbon rate of not less than 20% by mass, and (D) a flame retardant, wherein the polyethylene resin is dispersed as crystal particles in the resin composition, and the content of the polyethylene resin crystal particles having a major axis diameter of 0.1 to 10 μm and an aspect ratio of 1 to 10 is not less than 60% by number based on the total polyethylene resin crystal particle number. The resin composition has high mechanical strength and excellent non-flammability

This application is based on Japanese Patent Application No. 2010-231190, filed on Oct. 14, 2010 in Japanese Patent Office, the entire content of which is hereby incorporated by reference.

### FIELD OF THE INVENTION

The present invention relates to a resin composition comprising a polyester resin and/or a polyethylene resin as a main component.

### TECHNICAL BACKGROUND

A thermoplastic resin such as a polyester resin or a polyethylene resin or its resin composition is applied in a wide field as a material for containers, films for packing, home electric appliances, office automation appliances, auto-visual appliances, electrical and electronic parts, and automobile parts in view of its molding proccessability, mechanical property, heat resistant property, weather resistant property, appearance, sanitary property or economy. Therefore, an amount to be used of molding products made of the thermoplastic resin or its resin composition increases and is increasing year by year. Accordingly, an amount of used and waste molding products also is increasing more and more, which is a serious social problem.

Recently, laws such as “The Law for Promotion of Sorted Collection and Recycling of Containers and Packaging (The Containers and Packaging Recycling Law)” and “Law Concerning the Promotion of Procurement of Eco-Friendly Goods and Services by the State and Other Entities (Law on Promoting Green Purchasing)” have been successively executed. Thus, great attention has been drawn on a material recycling technology of a mold product made of a thermoplastic resin or a resin composition containing the same. Particularly, a material recycling technology is urgently required which recycles PET bottles made of polyethylene terephthalate (hereinafter also referred to as PET) which rapidly increases their usage. Further, as optical recording medium products (optical discs) such as CD, CD-R, DVD and MD made of polycarbonate (hereinafter also referred to as PC) prevail, a method has been studied which reuses wastes generated during molding of the optical discs or PC obtained after peeling of the reflection layer and the recording layer from the optical discs.

However, used molding products recovered from the market such as PET bottles made of polyester resin or optical discs made of polycarbonate resin often degrade due to hydrolysis or thermal decomposition. For example, when these products are pulverized and re-molded, its mechanical strength is extremely poor, resulting in incapability of re-molding. Further, if re-molding can be carried out, the obtained molding products are fragile and likely to be damaged. Therefore, it is considered that it is difficult to reuse these products into molding products capable of being practically used.

So, in order to increase mechanical strength of the polyester resin or the polycarbonate resin, it is known that a gum component is added to the resin. However, this method has problems in that elasticity is lowered and a sufficient mechanical strength in not obtained. Further, in order to solve these problems, a method is considered in which components with high elasticity are added to the resin in addition to the gum components, however, in this method, the resin is plasticized, resulting in lowering the toughness, and a sufficient mechanical strength in not still obtained.

When the thermoplastic resin such as a polyester resin or a polyethylene resin or its resin composition is applied as constituent parts for home electrical appliances or office automation appliances, the constituent parts are required to have sufficient non-flammability. So, in order to obtain sufficient mechanical strength and non-flammability, a method is proposed in which a gum component and a flame retardant are added to the resin (refer to Japanese Patent O.P.I. Publication Nos. 2003-183486, 2003-213112, 2003-221498 and 2003-231796). However, this method has problem in that sufficient mechanical strength is not obtained due to halogen atoms contained in the flame retardant.

### SUMMARY OF THE INVENTION

In view of the above, the present invention has been made. An object of the invention is to provide a resin composition having high mechanical strength and excellent non-flammability.

BRIEF EXPLANATION OF THE DRAWINGS

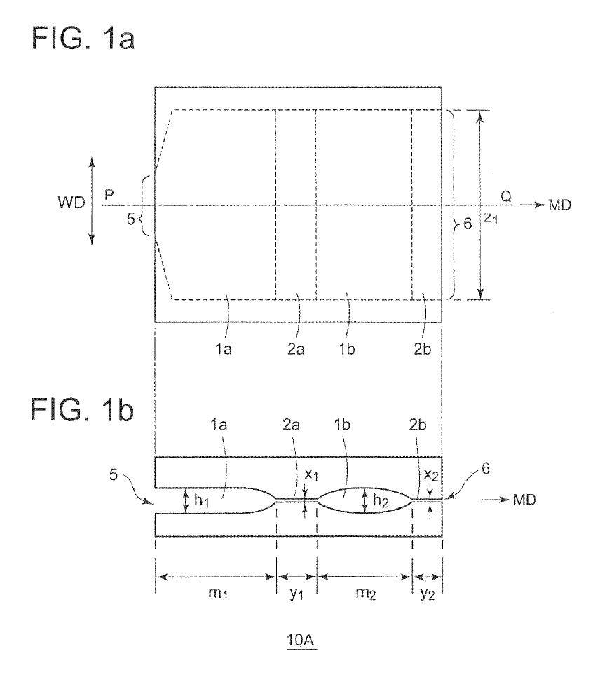

FIG. 1a is a view for explaining one embodiment of a structure of an apparatus (die) employed in a specific slit passing treatment for obtaining the resin composition of the invention and a plan view thereof.

FIG. 1b is a sectional view cut in line PQ in FIG. 1a.

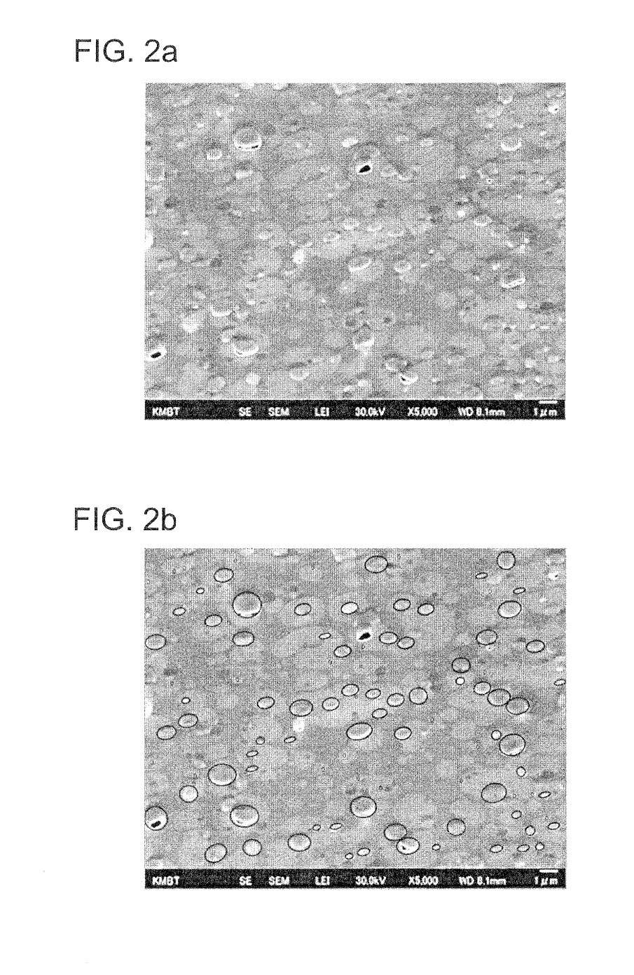

FIG. 2a is a photographic image of the section of the resin composition 1 in Example 1.

FIG. 2b is a photographic image in which the circumference of crystal particles of the component B in the photographic image of FIG. 2a is shown by a solid line.

### DETAILED DESCRIPTION OF THE INVENTION

The resin composition of the invention comprising (A) a polyester resin and/or a polycarbonate resin, (B) a polyethylene resin, (C) an aromatic compound having a residual carbon rate of not less than 20% by mass other than the polyester resin and the polycarbonate resin and (D) a flame retardant, wherein the polyethylene resin is dispersed as crystal particles in the resin composition, and the content of the polyethylene resin crystal particles having a major axis diameter of 0.1 to 10 μm and an aspect ratio of 1 to 10 is not less than 60% by number based on the total polyethylene resin crystal particle number.

The resin composition of the invention is preferably one obtained by subjecting a kneaded polymer composition in a melted state comprising (A) a polyester resin and/or a polycarbonate resin, (B) a polyethylene resin, (C) an aromatic compound having a residual carbon rate of not less than 20% by mass other than the polyester resin and the polycarbonate resin and (D) a flame retardant to slit passing treatment in which the kneaded polymer composition passes through a slit having a clearance of less than 5 mm.

It is preferred that the resin composition of the invention contains from 10 to 80% by mass of (A) the polyester resin and/or the polycarbonate resin, from 5 to 25% by mass of (B) the polyethylene resin, from 1 to 10% by mass of (C) an aromatic compound and from 0.1 to 20% by mass of (D) a flame retardant.

### Effect of the Invention

The resin composition of the invention containing crystal particles of (B) polyethylene resin having a specific shape dispersed in a specific content dispersed therein, a specific aromatic compound and a specific flame retardant, even when regenerated polyester resin or polycarbonate resin is employed, provides high mechanical strength and excellent non-flammability.

Next, the present invention will be explained in detail.

The resin composition of the invention is one in the solid form which comprises (A) a polyester resin and/or a polycarbonate resin, (B) a polyethylene resin B, (C) an aromatic compound and (D) an anti-flaming agent.

The component constituting the resin composition will be explained below.

[(A) Polyester Resin and/or Polycarbonate Resin]

A polyester resin and/or a polycarbonate resin (hereinafter also referred to as component A) is a main component constituting the resin composition of the invention.

### (Polyester Resin)

The polyester resin as component A is not specifically limited, and a polyester resin (hereinafter also referred to as regenerated polyester resin) obtained from a waste molded product can be utilized. Further, a polyester resin can be utilized which is obtained by polycondensation of a dicarboxylic acid or a derivative having an ester forming ability with a diol or a derivative having an ester forming ability according to a known method.

Examples of the dicarboxylic acid for forming a polyester resin as component A include an aromatic dicarboxylic acid such as terephthalic acid, isophthalic acid, 2,2′-biphenyldicarboxylic acid, 3,3′-biphenyldicarboxylic acid, 4,4′-biphenyldicarboxylic acid, 4,4′-diphenyl ether dicarboxylic acid, 1,5-naphthalenedicathoxylic acid, 1,4-naphthalenedicarboxylic acid, 2,6-naphthalenedicarboxylic acid, bis(p-carboxyphenyl)methane, anthracene dicarboxylic acid or sodium 5-sulfoisophthalate; aliphatic dicarboxylic acid such as adipic acid, sebatic acid, succinic acid, azelaic acid, malonic acid, oxalic acid or dodecanedionic acid; an alicyclic dicarboxylic acid such as 1,3-cyclohexane dicarboxylic acid, or 1,4-cyclohexane dicarboxylic acid; and dicarboxylic acids derived from their ester formation derivatives (for example, lower alkyl esters such as methyl esters or ethyl esters).

Examples of the diol for forming a polyester resin as component A include an aliphatic diol having a carbon atom number of from 1 to 10 such as ethylene glycol, 1,2-polypropylene glycol, 1,3-polypropylene glycol, 1,3-propanediol, 1,4-butanediol, 2,3-butanediol, 1,6-hexane diol, 1,10-decane diol, neopentyl glycol, 2-methylpropane diol, or 1,5-pentane diol; an alicyclic diol such as 4-cyclohexane dimethanol or 1,4-cyclohexane; and a polyalkylene glycol having a molecular weight of not more than 6000 such as diethylene glycol, polyethylene glycol, poly-1,3-propylene glycol or polytetramethylene glycol.

These dicarboxylic acids and diols may be used singly or as an admixture of two or more kinds thereof Further, the polyester resin as component A constituting the resin composition of the invention may have in the chemical structure a monomer unit derived from a monomer with three or more functional group such as glycerin, trimethylol propane, pentaerythritol, trimellitic acid or pyromellitic acid as long as the monomer unit content in the polyester resin is not more than 1% by mole based on the total monomer unit constituting the polyester resin.

The polyester resin is preferably an aromatic polyester resin obtained by polycondensation of an aromatic dicarboxylic acid or a derivative having an ester forming ability with an aliphatic diol or a derivative having an ester forming ability, in view of improved mechanical strength and ant-flaming property.

Examples of the polyester resin include polyethylene terephthalate (PET), polybutylene terephthalate (PBT), polypropylene terephthalate, polyethylene naphthalate (PEN), polybutylene naphthalate, poly-1,4-cyclohexanedimethylene terephthalate, polycaprolactone, p-hydroxybenzoic acid based polyesters, and polyarylate based resins. Among these, PET or PEN, which employs ethylene glycol as a diol component, is especially preferred in view of physical property balance among crystallization behavior, thermal property and mechanical property.

The polyester resin as component A is preferably one having an intrinsic viscosity of preferably from 0.5 to 1.5 dl/g, and more preferably from 0.65 to 1.3 dl/g. The polyester resin having an intrinsic viscosity as above provides good resistance to impact and good chemical resistance, and further has no adverse affect on other additives to be added, since it is not necessary to elevate the kneading temperature in order to prevent the viscosity from increasing during melt kneading treatment (1) described later.

Herein, the viscosity is measured at 30° C. employing phenolltetrachloroethane (1/1 by mass) as a solvent.

The polyester resin as component A is preferably one having a melting point of preferably from 180 to 300° C., and more preferably from 220 to 290° C. Further, the polyester resin as component A is preferably one having a glass transition point of preferably from 40 to 200° C., and more preferably from 50 to 150° C.

The melting point of the polyester resin is measured employing a differential scanning calorimeter DSC7020 (produced by Seiko Instruments Inc.), and refers to the end-point temperature of the crystal melting endotherm peak occurring during heating when it is measured employing the differential scanning calorimeter.

The glass transition point of the polyester resin is measured employing a differential scanning calorimeter DSC7020 (produced by Seiko Instruments Inc.), and specifically, it is measured as follows.

A sample (polyester resin) of 10 mg, which is weighed accurately to the second decimal place, is placed in a pan made of aluminum, and an empty aluminum pan is provided as the reference. A Heat-Cool-Heat temperature being controlled, the thermal properties of the sample are measured at a first heating rate of 10° C./min, at a cooling rate of 10° C./min and a second heating rate in that order in the temperature range of from 0 to 200° C., and analysis is carried out employing the data based on the second heating. In the invention, the glass transition point refers to a temperature at a point where the base line changes stepwise. That is, the glass transition point refers to a temperature at the point at which a curve at a position where the base line changes stepwise intersects a line equidistant in the longitudinal direction from each of a line extending from the base line before the point where the base line changes stepwise and a line extending from the base line after the point where the base line changes stepwise.

The content of the polyester resin as component A in the resin composition is preferably from 10 to 80% by mass, and more preferably from 10 to 70% by mass, based on the total amount of the resin composition.

(Polycarbonate resin)

The polyester polycarbonate resin as component A is not specifically limited, and a polycarbonate resin (hereinafter also referred to as regenerated polycarbonate resin) obtained from a waste molded product can be utilized. Further, as the polyester polycarbonate resin as component A, there can be used one which is obtained by reaction of a dihydric phenol with a carbonate precursor. As a manufacturing method of such a polycarbonate, a known method can be used and there are, for example, a method which directly reacts a dihydric phenol with a carbonate precursor such as phosgene (an interface polymerization method) and a method which carries out ester exchange reaction employing a dihydric phenol and a carbonate precursor such as diphenyl carbonate (a solution method).

Examples of the dihydric phenol for forming the polycarbonate resin as component A include hydroquinone, resorcin, dihydroxydiphenyl, bis(hydroxylphenyl)alkane, bis(hydroxylphenyl)cycloalkane, bis(hydroxylphenyl)sulfide, bis(hydroxylphenyl)ether, bis(hydroxylphenyl)ketone, bis(hydroxylphenyl)sulfone, bis(hydroxylphenyl)sulfoxide, bis(hydroxylphenyl)benzene, and their derivatives having a substituent such as an alkyl group or a halogen atom on the nucleus. Especially preferred examples of the dihydric phenol include 2,2-bis(4-hydroxyphenyl)propane (bisphenol A), 2,2-bis{(4-hydroxy-3-methyl)phenyl}propane, 2,2-bis {(3,5-dibromo-4-hydroxy)phenyl}propane, 2,2-bis(4-hydroxyphenyl}butane, 1,1-bis(4-hydroxyphenyl)cyclohexane, 1,1-bis(4-hydroxyphenyl)-3,3,5-trimethylcyclohexane, 4,4′-dihydroxydiphenylsulfone, and bis {(3,5-dimethyl-4-hydroxy)phenyl}sulfone. These can be used singly or as an admixture of two or more kinds thereof. Among these, bisphenol A is especially preferably used.

Examples of the carbonate precursor for forming the polycarbonate resin as component A include a diarylcarbonate such as diphenylcarbonate, ditoluylcarbonate or bis(chlorophenyl)carbonate; a dialkylcarbonate such as dimethylcarbonate or diethylcarbonate; a carbonyl halide such as phosgene; and a haloformate such as dihaloformate of a dihydric phenol, but are not limited thereto. Among these, diphenylcarbonate is preferred. These carbonate precursors also can be used singly or as an admixture of two or more kinds thereof.

The polycarbonate resin may be a branched polycarbonate resin having a comonomer unit derived from a bi-or more functional aromatic compound, i.e., a multi-functional aromatic compound such as 1,1,1-tris(4-hydroxyphenypethane or 1,1,1-tris(3,5-dimethyl-4-hydroxyphenypethane, or a polyester carbonate resin having a comonomer unit derived from an aromatic or aliphatic dicarboxylic acid. These polycarbonate resins may be used singly or as an admixture of two or more kinds thereof

The polycarbonate resin as component A has a viscosity average molecular weight of preferably from 10,000 to 40,000, and more preferably from 12,000 to 35,000.

The viscosity average molecular weight of the polycarbonate resin is measured employing CBM-20Alite System and GPC soft ware (each produced by Shimazu Seisakusho Co., Ltd.

The polycarbonate resin as component A has a glass transition temperature of preferably from 120 to 290° C., and more preferably from 140 to 270° C. The glass transition temperature of the polycarbonate resin is measured in the same manner as denoted above in the polyester resin.

The content of the polycarbonate resin in the resin composition is preferably from 10 to 80% by mass, and more preferably from 30 to 80% by mass, each based on the total amount of the resin composition.

It is preferred in the invention that as the component A, the polyester resin and the polycarbonate resin are used in combination. When the polyester resin and the polycarbonate resin are used in combination, the content ratio by mass of the polyester resin to the polycarbonate resin is preferably from 9:1 to 1:9, and more preferably from 7:3 to 3:7.

### [Polyethylene Resin B]

The polyethylene resin B (hereinafter also referred to as component B) contained in the resin composition of the invention is a component constituting the resin composition of the invention, and the component B is dispersed as crystal particles in the resin composition.

In the invention, the content of the component B (polyethylene resin) crystal particles having a major axis diameter of 0.1 to 10 μm and an aspect ratio (major axis diameter/minor axis diameter) of from 1 to 10 is from 60 to 100% by number and preferably from 70 to 100% by number, based on the total component B (polyethylene resin) crystal particle number.

The content range as above of the crystal particles of the component B can give high mechanical strength to the resin composition. However, when the content of the crystal particles of the component B is too low, a resin composition with high mechanical strength cannot be obtained.

The content rate by number of the crystal particles in the invention to the total crystal particle number is determined as follows. The resin composition in the pellet form or the molded product made of the resin composition is cut through a microtome provided with a diamond blade to prepare a sample in thin section. The section of the resulting sample is photographed by a transmission electron microscope (MODEL LEM-2000) (produced by Topton Corporation) at a magnification of 5000 to obtain the photographic image. In this photographic image (150 mm×150 mm), the number of images which are confirmed as crystal particles of the component B is counted, and the content rate (% by number) of crystal particles having a major axis diameter of from 0.1 to 10 μm and an aspect ratio of from 1 to 10 to the total crystal particle number is determined.

Herein, with respect to definition of the major axis diameter and the minor axis diameter of the crystal particles in the invention, explanation will be made below.

When in the projected image of the crystal particle photographed by a transmission electron microscope, two straight lines parallel to each other are drawn to be tangent to the projected image at two points on the outer circumference of the projected image, a length of the longest straight line segment of straight line segments connecting the two points on the outer circumference of the projected image is defined as the major axis diameter of the crystal particle, and a length of a straight line segment, which is a perpendicular bisector of the longest straight line segment, and has both ends on the outer circumference of the projected image, is defined as the minor axis diameter of the crystal particle.

In the invention, it is more preferred that in the resin composition of the invention, the content of the component B (polyethylene resin) crystal particles having a major axis diameter of 0.1 to 5 μm and an aspect ratio (major axis diameter/minor axis diameter) of from 1 to 5 is from 60 to 100% by number, based on the total component B (polyethylene resin) crystal particle number. This constitution can give higher mechanical strength to the resin composition.

The component B is not specifically limited, and a polymer which is obtained by polymerization of ethylene can be used as the component B. Typical examples thereof include a high density polyethylene (HDPE), a low density polyethylene (LDPE), a very low density polyethylene (VLDPE), and a linear low density polyethylene (LLDPE). HDPE is preferably used in view of mechanical strength and non-flammability.

The component B has a melting point of preferably from 70 to 170° C., and more preferably from 90 to 140° C. The melting point of the component B is measured in the same manner as denoted above in the polyester resin.

The content of the component B in the resin composition is preferably from 5 to 25% by mass, and more preferably from 5 to 15% by mass, based on the total amount of the resin composition. The above content range of the component B in the resin composition can give a sufficient mechanical strength and a self-extinguishing property to the resin composition.

### [Aromatic Compound C]

The aromatic compound C (hereinafter also referred to as component C) contained in the resin composition of the invention is a component constituting the resin composition of the invention, and has a residual carbon rate of from 20 to 100% by mass. In the invention, the aromatic compound refers to a cyclic unsaturated organic compound other than component A.

In the invention, the residual carbon rate refers to the rate of change of mass measured by a thermogravimetric method.

Specifically, the residual carbon rate is determined as follows. The component C of 10 mg is placed in a platinum cell, introduced in a thermogravimetric analyzer “TGDTA 6200” produced by Seiko Instruments Inc., and heated from 25 to 500° C. at a heating rate of 10° C./min under a nitrogen atmosphere (of a flow rate of 300 mm/min). Then, the masses of the component C before and after heating are measured, and the residual carbon rate is determined by the following formula (1),

Residual carbon rate (% by mass)=(W2/W1)×100 Formula (1)

wherein W1 is the mass of the component C before heating, and W2 is the mass of the component C after heating.

The above range of the residual carbon rate can give sufficient heat resistance to the component C, and as a result, sufficient non-flammability is given to the resin composition. The component C has a high residual carbon rate, in which mass variation due to heating is small, and has heat resistance. In the invention, the component C has a function contributing to non-flammability of the resin composition.

As the component C, for example, polyphenylene ether, polyphenylene vinylene or polyphenylene sulfide (hereinafter also referred to as PPS) can be preferably used. Among these, PPS is especially preferred. PPS has a molecular weight of from ______ to ______. PPS is polyphenylene sulfide useful for so-called engineering plastic.

PPS has a melt index MI of preferably from 50 to 100 g/ten minutes. The melt index is measured at 316° C. and at a load of 2.16 kg according to ASTM D1238, employing a melt indexer SEMI AUTO MELT INDEXER 2A (produced by Toyo Seiki Seisakusho Co., Ltd.).

As typical commercially available products of PPC, there are mentioned TORELINA (produced by Toray Co., Ltd.) and PPC (trade name, produced by DIC).

The content of the component C in the resin composition is preferably from 1 to 10% by mass, and more preferably from 1 to 5% by mass, based on the total amount of the resin composition.

### [Flame Retarder D]

The flame retardant D contained in the resin composition of the invention (hereinafter also referred to as Component D) is a component constituting the resin composition of the invention. As the component D, there is an organic flame retardant such as an organic phosphorous compound. Examples of the organic phosphorous compound include a phosphorous acid ester, a phosphoric acid ester, a phosphonous acid ester and a phosphonic acid ester.

Examples of the phosphorous acid ester include triphenyl phosphite, tris(nonylphenyl) phosphite, tris(2,4-di-t-butylphenyl) phosphite, distearylpentaerythritol diphosphite, bis(2,6-di-t-butyl-4-methylphenyl)pent aerythritol diphosphite, and bis(2,4-di-t-butylphenyl)pentaerythritol diphosphite.

Examples of the phosphoric acid ester include triphenyl phosphate (hereinafter also referred to as TPP), tris(nonylphenyl) phosphate, nis(2,4-di-t-butylphenyl) phosphate, distearylpentaerythritol diphosphate, bis(2,6-di-t-butyl-4-methylphenyl)pentaerythiitol diphosphate, bis(2,4-di-t-butylphenyl)pentaerythritol diphosphite, tributyl phosphate and bisphenol A bis(diphenyl phosphate).

Examples of the phosphonous acid ester include tetrakis(2,4-di-t-butylphenyl)-4,4′-biphenylene phosphonite.

Examples of the phosphonic acid ester include benzenephosphonic acid dimethyl ester and benzenephosphonic acid esters.

As the phosphoric acid ester compound, esters of phosphorous acid, phosphoric acid and phosphonic acid are preferred, and esters of phosphoric acid are especially preferred.

The content of the component D in the resin composition is preferably from 0.1 to 20% by mass, and more preferably from 1 to 10% by mass, based on the total amount of the resin composition.

The resin composition of the invention can contain another conventional additive in addition to the components A, B, C and D, as long as the object of the invention is attained. Examples of the another conventional additive include a cross-linking agent (for example, phenol resin), pigments, dyes, reinforced materials (for example, glass fiber, carbon fiber, talc, mica, clay mineral, potassium titanate fiber, etc.), fillers (for example, titanium oxide, metal powder, wood powder, rice husks, etc.), a thermal stabilizer, an anti-oxidant, a UV absorber, a sliding agent, a releasing agent, a crystal nucleus agent (for example, GMA-MA-PE), a plasticizer, an anti-static agent, and a foaming agent.

The content of these additives is preferably from 0.01 to 10% by mass, and more preferably from 0.1 to 5% by mass, based on the total amount of the resin composition.

### [Manufacturing Method of Resin Composition]

The manufacturing method of the resin composition of the invention is not specifically limited, but it is preferred that the method is one in which the polymer mixture comprising at least Components A, B, C and D is subjected to melt kneading treatment (I), and the resulting melted kneaded polymer composition is subjected to a specific slit pass treatment (II) as described later and then to cooling treatment (III) to obtain the resin composition of the invention. The thus obtained resin composition is cut with for example, a pelletizer to form into pellets, so that the composition is easily processed in a subsequent processing step (for example, a molding step).

In the invention, the slit passing treatment refers to treatment in which a kneaded polymer composition hi the melted state is allowed to pass through a slit having a minute clearance.

### (I) Melt Kneading Treatment

The melt kneading treatment is carried out employing, for example, an extruder. The extruder is not specifically limited and a known extruder employing shear force can be utilized. Examples of the extruder include twin screw extruding kneaders such as KTX 30 (produced by Kobe Seiko Co., Ltd.) and KTX 46 (produced by Kobe Seiko Co., Ltd.).

The melt kneading treatment conditions are not specifically limited, but the treatment is carried out under for example, a screw rotation rate of from 50 to 1000 rpm and a melt kneading temperature of from 150 to 500° C.

### (II) Specific Slit Passing Treatment

The specific slit passing treatment is carried out according to a method in which after a kneaded polymer composition is melt kneaded, the kneaded polymer composition in the melted state is allowed to pass through a slit having a clearance of less than 5 mm. It is considered that such a specific slit passing treatment provides Component (B) which is highly dispersed in the kneaded polymer composition.

When the kneaded polymer composition in the melted state is passing through a slit, a pressure applied to the kneaded polymer composition or the moving speed of the kneaded polymer composition greatly varies. Herein, it is considered that during the slit passing treatment, a shearing action, an elongation action and a folding action effectively operate on the kneaded polymer composition. It is, therefore, considered that the component (B) is present in a highly dispersed state in the kneaded polymer composition subjected to such an action.

It is preferred in the resin composition of the invention that the specific slit passing treatment is repeatedly carried out one or more times, preferably two or more times, and more preferably three or more times. When the number of the specific slit passing treatments is increased, the mechanical strength of the resin composition is markedly increased. The upper limit of the number of the specific slit passing treatments is ordinarily 1000. When the resin composition of the invention is kneaded in a single or twin screw extruder and then subjected to the specific slit passing treatments, the number of the specific slit passing treatments can be reduced. When the resin composition of the invention is subjected to the specific slit passing treatments, employing, for example, an apparatus connected with the ejection outlet of a twin screw extruder, the number of the specific slit passing treatments can be reduced to three to ten.

The clearance of the slit is less than 5 mm, and preferably from 1 to 3 mm. Further, when the apparatus having two or more slits is employed, for example, clearances of the two or more slits independently are less than 5 mm, and preferably from 1 to 3 mm. When the clearance of the slit is not less than 5 mm, a pressure applied to the kneaded polymer composition during the slit passing treatment is insufficient, which does not provide component (B) present in a highly dispersed state in the kneaded polymer composition.

Next, as a specific slit passing treatment, a method will be explained which employs an apparatus having two slits with a clearance of less than 5 mm arranged in series.

FIGS. 1a and 1b are views for explaining one embodiment of a structure of an apparatus (die) employed in a specific slit passing treatment for obtaining the resin composition of the invention. FIG. 1a is a plan view of the apparatus and FIG. 1b is a sectional view thereof cut in line PQ in FIG. 1a.

This apparatus 10A is equipped with a housing substantially in the cuboid shape, an introduction inlet 5 for introducing a material to be treated, an ejection outlet 6 for ejecting a treated material, and two of a slit (2a, 2b) formed between two planes parallel to each other in a path between the introduction inlet 5 and the ejection outlet 6 in which the material to be treated flows, the two slits being arranged in series.

The slits 2a and 2b have reservoirs 1a and 2a immediately before the slits 2a and 2b, respectively, the sectional area of the reservoirs 1a and 1b being larger than that of the slits 2a and 2b.

This apparatus 10A has a structure such that the introduction inlet 5 is connected with an ejection outlet of an extruding kneader (not illustrated), and utilizing an extruding force due to the kneader as a driving force for moving a kneaded polymer composition, it can move the kneaded polymer composition in the moving direction MD and pass through the slits 2a and 2b. The apparatus 10A can be connected with an ejection outlet of an extruding kneader, and can be called a die.

The kneaded polymer composition in the melted state is introduced into the reservoir 1a from the introduction inlet 5, and spreads in the width direction WD. The kneaded polymer composition with which the reservoir 1a is filled passes through the slit 2a to the reservoir 1b, passes through the slit 2b, and then is ejected from the ejection outlet 6.

The clearance x₁ of the slit 2a is 3 mm, and the clearance x₂ of the slits 2b is 3 mm.

The lengths y₁ and y₂ in the moving direction MD of the slits 2a and 2b are preferably from 2 to 200 mm, and more preferably from 5 to 50 mm. The length y₁ in the moving direction (MD) of the slit 2a is specifically 50 mm, and the length y₂ in the moving direction (MD) of the slit 2b is specifically 40 mm.

The length Z₁ in the width direction WD of the slits 2a and 2b are preferably from 10 to 500 mm, and more preferably from 50 to 300 mm. The length Z₁ in the width direction WD of the slits 2a and 2b is specifically 250 mm. In the invention, the width direction WD refers to the direction normal to the moving direction MD in the horizontal plane.

The maximum heights h₁ and h₂ of the reservoirs 1a and 1b are preferably from 3 to 150 mm, and more preferably from 5 to 100 mm. The maximum heights h₁ and h₂ of the reservoirs 1a and 1b are specifically 50 mm, respectively. In the invention, the maximum height of the reservoir refers to the maximum height of the plane normal to the width direction.

The lengths m₁ and m₂ in the moving direction MD of the reservoirs 1a and 1b may independently be not less than 1 mm, and are preferably not less than 2 mm, more preferably 5 mm, and still more preferably 10 mm, in view of efficiency. The lengths m₁ and m₂ are specifically 100 mm, respectively.

The upper limit of the lengths m₁ and m₂ is not specifically limited, however, when the lengths m₁ and m₂ are too great, efficiency is lowered and it is necessary to enhance the extrusion force of an extrusion kneader connected with the die through the introduction 5. Accordingly, the lengths m₁ and m₂ independently are preferably from 1 to 300 mm, more preferably from 2 to 100 mm, and still more preferably from 5 to 50 mm.

The ratio S₁ₐ/S₂ₐ of the maximum sectional area S₁ₐ of the reservoir 1a before the slit 2a to the sectional area S₂ₐ of the slit 2a and the ratio S_{1b}/S_{2b} of the maximum sectional area S_{1b} of the reservoir 1b before the slit 2b to the sectional area S_{2b} of the slit 2b independently are ordinarily not less than 1.1, and preferably from 1.1 to 1000. The ratios S₁ₐ/S₂ₐ, and S_{1b}/S_{2b} independently are more preferably from 2 to 100, and still more preferably from 3 to 15, in view of uniform mixing and dispersion, miniturization of the apparatus and vent-up prevention.

The flow rate at which the kneaded polymer composition in the melted state passes through the slit may be not less than 1 g/min per 1 cm² of the slit sectional area, and is preferably from 10 to 5000 g/min per 1 cm² of the slit sectional area, and more preferably from 10 to 500 g/min per 1 cm² of the slit sectional area.

In the invention, the sectional area refers to an area of the section perpendicular to the moving direction MD.

In the invention, the flow rate refers to a value obtained by dividing an ejecting amount (g/min) of the kneaded polymer composition ejected from an ejection outlet by the sectional area (cm²) of the slit.

The viscosity of the kneaded polymer composition during the slit passing treatment is not specifically limited as long as the flow rate as described is secured, however, the viscosity of the composition is for example, from 1 to 10000 Pa.s, and preferably from 10 to 8000 Pa.s.

The viscosity of the kneaded polymer composition is measured according to a viscoelastometer “MARS” produced by Haake Co., Ltd.

The pressure for moving the kneaded polymer composition in the melted state in the moving direction MD is not specifically limited, as long as the flow rate at which the composition in the melted state passes through the slit is one as described above. The pressure is preferably not less than 0.1 MPa in terms of resin pressure represented by the difference from the atmospheric pressure. Herein, the resin pressure refers to a pressure of the kneaded polymer composition at a position in the slit 1 mm distant from a slit ejection outlet, and it can be directly measured through a pressure gauge. The higher pressure is more effective. However, when the resin pressure is too high, shear heating is generated which may result in decomposition of the polymer. Accordingly, the resin pressure is preferably 500 MPa or less, and more preferably 50 MPa or less.

The temperature of the kneaded polymer composition during the slit passing treatment is not specifically limited, as long as the flow rate as described is secured, however, it is preferably not higher than 400° C., since a high temperature exceeding 400° C. causes decomposition of the polymer. The temperature is more preferably from 200 to 350° C. When the temperature of the kneaded polymer composition during the slit passing treatment is not less than a glass transition temperature of the polymer, it is desirable since the resin pressure is not extremely high.

The temperature of the kneaded polymer composition during the slit passing treatment can be controlled by adjusting a heating temperature of an apparatus carrying out the slit passing treatment.

### (III) Cooling Treatment

The cooling treatment is not specifically limited, and is carried out, for example, by a method in which the kneaded polymer composition subjected to the slit passing treatment is immersed in a 0 to 60° C. water, a method in which the kneaded polymer composition subjected to the slit passing treatment is cooled by a −40 to 60° C. air or a method in which the kneaded polymer composition subjected to the slit passing treatment is brought into contact with a −40 to 60° C. metal. Alternatively, the kneaded polymer composition subjected to the slit passing treatment may be allowed to stand to be cooled. Employing these methods, crystal particles of Component B are effectively maintained in a highly dispersed state.

The thus obtained resin composition is ordinarily cut by a pelletizer, whereby the treatment carried out in a subsequent step is facilitated.

In order to obtain the resin composition of the invention, all the components constituting the resin composition may be mixed prior to the melt kneading treatment (I) as described above and subjected to pre-mixing treatment. Further, the resin composition subjected to pre-mixing treatment is preferably dried prior to the melt kneading treatment (1) in order to prevent hydrolysis of the polyester resin therein.

The method for manufacturing the resin composition of the invention is not specifically limited to those as described above, and can be added with various modifications.

Even when a regenerated polyester resin or a regenerated polycarbonate resin is contained in the resin composition of the invention, the resin composition of the invention, in which the crystal particles of Component B in a specific form are dispersed in a specific amount, provides high mechanical strength, and the resin composition of the invention, in which a specific aromatic compound and a specific flame retardant are contained, provides excellent flame retardancy.

Next, the present invention will be explained referring to examples, but is not limited thereto.

### EXAMPLES

### Example 1

Each of the components as shown in Table 1 was drive blended in a given amount by mass in a V-shaped mixer, and dried at 60° C. for 4 hours under vacuum in a vacuum dryer. Thus, the pre-mixing treatment was carried out. The resulting dry mixture was incorporated in a twin-screw extruding kneader KTX 30 (produced by Kobe Seiko Co., Ltd.) from the raw material supply inlet, and subjected to melt-kneading treatment under conditions such that the ejecting amount was 30 kg/hour, the resin pressure was 4 MPa, and the screw rotation rate was 250 rpm. In the twin-screw extruding kneader, the cylinder portion was composed of nine blocks C1 through C9 each being provided with a temperature adjusting block, the C1 portion was provided with the raw material supply inlet, the C3 and C7 portions ware provided with a screw combination of the rotor and kneader and the C8 portion was provided with a vent. Subsequently, employing a die similar to one as shown in FIGS. 1a and 1b, the resulting melt-kneaded polymer mixture ejected from the twin-screw extruding kneader was subjected to slit passing treatment under the following slit passing treatment conditions in which the ejected melt-kneaded mixture was introduced from the introduction inlet (5), allowed to pass through a given slit (2a, 2b) and ejected from the ejection outlet (6). The polymer mixture ejected from the die was immersed in a 30° C. water, cooled and cut through a pelletizer to obtain a resin composition (1) in the pellet shape.

### Slit Passing Treatment Conditions

Flow Rate of the Melt-kneaded Polymer Mixture; 30 kg/hour
Resin Pressure of the Melt-kneaded Polymer Mixture; 4 PMa
Temperature of the Melt-kneaded Polymer Mixture; 290° C.

### Examples 2 Through 4 and Comparative Examples 1 Through 3

The resin compositions (2) through (7) were prepared in the same manner as the resin composition (1), except that the kind of each component, the amount of the component and the clearance of the slit in the slit passing treatment were changed to those as shown in Table 1.

In the resin compositions 1 through 7, the content (% by number) of Component B having a major axis diameter of from 0.1 to 10 μm and an aspect ratio of from 1 to 10 was determined by the measuring method described above, and the residual carbon rate of Component C was measured by the measuring method described above.

With respect to the resin composition 1 of Example 1, the section of the resin composition 1 was photographed by a transmission electron microscope (MODEL LEM-2000) (produced by Topcon Corporation) to obtain a photographic image. The photographic image is shown in FIG. 2a and in FIG. 2b. In FIG. 2b, images which are confirmed as crystal particles of the component B are surrounded by a solid line.

In this photographic image (150 mm×150 mm), the total number of images which were confirmed as crystal particles of the component B was 113, and the number of images of crystal particles having a major axis diameter of from 0.1 to 10 μm and an aspect ratio of from 1 to 10 was 72.

TABLE 1

| | | Component A | | | Component B | | | | | | | |
|---|---|---|---|---|---|---|---|---|---|---|---|---|
| | | Polyester | | Poly- | Poly- | | Component C | | Component | Other Additives | | |
| | | Resin | | carbonate | ethylene | | | Residual | D | Phenol | GMA- | |
| | Resin | PET | PEN | Resin | Resin | | PPS | Carbon | TPP | Resin | MA-PE | Slit |
| | Composition | Content | | | Content | | Content | Rate | Content | Content | | Clearance |
| | No. | (% by mass) | | | (% by mass) | *** | (% by mass) | (% by mass) | (% by mass) | (% by mass) | | (mm) |
| *Ex. 1 | 1 | 41.0 | 4.5 | 41.0 | 5.0 | 64 | 4.0 | 45 | 3.0 | 1.0 | 0.5 | 3 |
| Ex. 2 | 2 | 37.5 | 4.5 | 37.5 | 10.0 | 63 | 5.0 | 45 | 3.0 | 2.0 | 0.5 | 3 |
| Ex. 3 | 3 | 36.0 | 4.5 | 36.0 | 15.0 | 67 | 4.0 | 45 | 3.0 | 1.0 | 0.5 | 3 |
| Ex. 4 | 4 | 35.0 | 4.5 | 35.0 | 15.0 | 69 | 5.0 | 45 | 3.0 | 2.0 | 0.5 | 3 |
| **Comp. | 5 | 21.8 | 4.0 | 21.8 | 40.0 | 19 | 8.0 | 45 | 3.0 | 1.0 | 0.5 | 3 |
| Ex. 1 | | | | | | | | | | | | |
| Comp. Ex. 2 | 6 | 18.5 | 9.0 | 18.5 | 40.0 | 14 | 8.0 | 45 | 3.0 | 2.0 | 1.0 | 3 |
| Comp. Ex. 3 | 7 | 38.5 | 4.5 | 38.5 | 10.0 | 11 | 4.0 | 45 | 3.0 | 1.0 | 0.5 | 10 |

*Ex.: Example;
**Comp. Ex.: Comparative Example
***: Content (% by number) of crystal particles having a major axis diameter of from 0.1 to 10 μm and an aspect ratio of from 1 to 10

In Table 1, the “PET” of component A is one (with an intrinsic viscosity of 0.90 dl/g, a melting point of 270° C. and a glass transition temperature of 76° C.) obtained from waste PET bottles, the “PEN” of component A is Teonex (with a melting point of 275° C. and a glass transition temperature of 118° C.) (produced by Teijin Kasei Co., Ltd.), and the “polycarbonate resin” of the component A is one (with a viscosity average molecular weight of about 15000, and a glass transition temperature of 148° C.) obtained from waste optical discs.

The “polyethylene resin” of component B is “HI-ZEX” (with a melting point of 136° C.) (produced by Prime Polymer Co., Ltd.).

The “PPS” of component C is “TORELINA” (produced by Toray Co., Ltd.).

The “TPP” of component D is “triphenyl phosphate” (produced by Daihachi Kagaku Kogyo Co., Ltd.).

In other additives used, the “phenol resin” as a cross-linking agent is “Sumilite Resin” (produced by Sumitomo Bakelite Co., Ltd.), and “GMA-MA-PE” as the crystal nucleus agent is “Bondfast” (produced by Sumitomo Kagaku Co., Ltd.).

### <Evaluation>

### (1) Mechanical Strength

Each of the resulting resin compositions 1 through 7 in the pellet form was dried at 80° C. for 4 hours, and molded at a cylinder temperature of 280° C. at a mold temperature of 40° C., employing an injection molding machine J55ELII (produced by Nippon Seikosho Co., Ltd.). Thus, a strip sample with a size of 100 mm×10 mm×4 mm was prepared. The resulting sample was determined for mechanical strength according to the following methods. The results are shown in Table 2.

### [Charpy Impact Strength]

The Charpy impact test (U notch, R=1 mm) was carried out according to JIS-K7111, and evaluated according to the following criteria.
A: Not less than 42 kJ/m²
B: From 32 kJ/m² to less than 42 kJ/m²
C: From 6 kJ/m² to less than 32 kJ/m² (practically non-problematic)
D: Less than 6 kJ/m² (practically problematic)

### [Bending Strength]

The bending test was carried out according to JIS-K7171, and evaluated according to the following criteria.
A: Not less than 70 MPa
B: From 66 MPa to less than 70 MPa
C: 50 MPa to less than 66 MPa (practically non-problematic)
D: Less than 50 MPa (practically problematic)

### [Elasticity]

Elasticity was determined from the initial stress in the bending strength test and evaluated according to the following criteria.
A: Not less than 3.0 GPa
B: From 2.1 GPa to less than 3.0 GPa
C: 2.0 GPa to less than 2.1 GPa (practically non-problematic)
D: Less than 2.1 GPa (practically problematic)

### (2) Non-Flammability

Each of the resulting resin compositions 1 through 7 in the pellet form was dried at 100° C. for 4 hours, and molded into a strand sample with a length of 100 cm, employing a twin screw extruding kneader KTX 30 (produced by Kobe Seiko Co., Ltd.) equipped with a strand die as the die. molding apparatus J55ELII (produced by Nippon Seikosho Co., Ltd.). The resulting sample was hung inclined by 45° with respect to a vertical line and pinned at a portion 10 cm distant from one end. Then, the other end of the sample was fired and evaluated according to the following criteria. The results are shown in Table 2.
A: Fire self-extinguished at a burning distance of less than 0.3 cm, and a length of the carbonized portion was less than 0.3 cm.
B: Fire self-extinguished at a burning distance of less than 2 cm, and a length of the carbonized portion was from 0.3 cm to less than 2 cm.
C: Fire self-extinguished at a burning distance of less than 5 cm, and a length of the carbonized portion was from 2 cm to less than 5 cm (practically non-problematic).
D: Fire traveled 5 cm or more, and a length of the carbonized portion was not less than 5 cm (practically problematic).

In the above, “a burning distance” refers to a length of a flame traveled portion without being carbonized.

TABLE 2

| | Resin | Evaluation Results | | | |
|---|---|---|---|---|---|
| | Composition | Impact | Bending | | Non- |
| | No. | Strength | Strength | Elasticity | flammability |
| Ex. 1 | 1 | A | A | A | A |
| Ex. 2 | 2 | A | A | A | A |
| Ex. 3 | 3 | B | B | B | B |
| Ex. 4 | 4 | B | B | A | B |
| Comp. Ex. 1 | 5 | C | D | D | D |
| Comp. Ex. 2 | 6 | C | D | D | D |
| Comp. Ex. 3 | 7 | D | D | D | C |

Ex.: Example, Comp. Ex.: Comparative Example

As is apparent from Table 2, the inventive resin compositions provide high mechanical strength and excellent non-flammability, as compared with the comparative resin compositions.

What is claimed is:

1. A resin composition comprising:
(A) a polyester resin or a polycarbonate resin;
(B) a polyethylene resin;
(C) an aromatic compound other than the polyester resin and the polycarbonate resin, the aromatic compound having a residual carbon rate of not less than 20% by mass; and
(D) a flame retardant,
wherein the polyethylene resin is dispersed as crystal particles in the resin composition, and the content of the polyethylene resin crystal particles having a major axis diameter of 0.1 to 10 μm and an aspect ratio of 1 to 10 is not less than 60% by number based on the total polyethylene resin crystal particle number.

2. The resin composition of claim 1, which is obtained by melt-kneading a polymer composition comprising (A) a polyester resin or a polycarbonate resin, (B) a polyethylene resin, (C) an aromatic compound other than the polyester resin and the polycarbonate resin, the aromatic compound having a residual carbon rate of not less than 20% by mass, and (D) a flame retardant to form a kneaded polymer composition in a melted state and subjecting the kneaded polymer composition to slit passing treatment in which the kneaded polymer composition passes through a slit having a clearance of less than 5 mm.

3. The resin composition of claim 1, wherein the resin composition contains from 10 to 80% by mass of the polyester resin or the polycarbonate resin, from 5 to 25% by mass of the polyethylene resin, from 1 to 10% by mass of the aromatic compound and from 0.1 to 20% by mass of the flame retardant.

4. The resin composition of claim 1, wherein the polyester resin has an intrinsic viscosity of from 0.5 to 1.5 dl/g at 30° C.

5. The resin composition of claim 1, wherein the polyester resin has a glass transition point of from 40 to 200° C.

6. The resin composition of claim 1, wherein the polycarbonate resin has a viscosity average molecular weight from 10,000 to 40,000.

7. The resin composition of claim 1, wherein the polycarbonate resin has a glass transition point of from 120 to 290° C.

8. The resin composition of claim 1, wherein the polyethylene resin crystal particles have a major axis diameter of 0.1 to 5 μm and an aspect ratio of 1 to 5.

9. The resin composition of claim 1, wherein the polyethylene resin has a melting point of from 70 to 170° C.

10. The resin composition of claim 1, wherein the aromatic compound is polyphenylene sulfide.

11. The resin composition of claim 10, wherein the polyphenylene sulfide has a melt index MI of from 50 to 100 g/10 minutes.

12. The resin composition of claim 1, wherein the flame retardant is selected from the group consisting of a phosphorous acid ester, a phosphoric acid ester, a phosphonous acid ester and a phosphonic acid ester.

13. The resin composition of claim 12, wherein the flame retardant is a phosphoric acid ester.

14. The resin composition of claim 1 comprising (A) a thermoplastic polyester resin and a thermoplastic polycarbonate resin, wherein the content ratio by mass of the polyester resin to the polycarbonate resin is from 9:1 to 1:9.

15. The resin composition of claim 14, wherein the content ratio by mass of the polyester resin to the polycarbonate resin is from 7:3 to 3:7.

16. A manufacturing method of a resin composition comprising the steps of:
melt-kneading a polymer composition comprising (A) a polyester resin or a polycarbonate resin, (B) a polyethylene resin, (C) an aromatic compound other than the polyester resin and the polycarbonate resin, the aromatic compound having a residual carbon rate of not less than 20% by mass, and (D) a flame retardant to form a kneaded polymer composition in a melted state; and
subjecting the kneaded polymer composition to slit passing treatment in which the kneaded polymer composition passes through a slit having a clearance of less than 5 mm,
wherein the polyethylene resin is dispersed as crystal particles in the resin composition, and the content of the polyethylene resin crystal particles having a major axis diameter of 0.1 to 10 μm and an aspect ratio of 1 to 10 is not less than 60% by number based on the total polyethylene resin crystal particle number.
